(19) United States
(12) Patent Application Publication
(10) Pub. No.: US 2023/0316119 A1
(43) Pub. Date: Oct. 5, 2023

(54) QUANTUM APPROXIMATION OPTIMIZER FOR DISTRIBUTED REGISTER VALIDATION

(71) Applicant: BANK OF AMERICA CORPORATION, Charlotte, NC (US)

(72) Inventors: Maharaj Mukherjee, Poughkeepsie, NY (US); Jinna Zevulun Kim, Charlotte, NC (US)

(73) Assignee: BANK OF AMERICA CORPORATION, Charlotte, NC (US)

(21) Appl. No.: 17/708,977

(22) Filed: Mar. 30, 2022

(51) Int. Cl. G06N 10/20; G06N 10/80

(52) U.S. Cl. CPC G06N 10/20; G06N 10/80

(57) ABSTRACT

A system for validating one or more blocks of a distributed register typically includes a classical computer apparatus and a quantum optimizer in communication with the classical computer apparatus. The classical computer apparatus is configured for receiving an interaction, authenticating the interaction, creating a block representing the interaction to be placed in a distributed register, transmitting the block representing the interaction to the quantum optimizer. The quantum optimizer in response to receiving the block representing the interaction, validates the block and transmits the validated block to the validation application.

### BACKGROUND

Conventional systems do not have the capability to validate one or more blocks of a distributed register efficiently. As such, a need exists for an improved way of validating one or more blocks of a distributed register.

### SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Embodiments of the present invention address the above needs and/or achieve other advantages by providing apparatuses (e.g., a system, computer program product and/or other devices) and methods for validating one or more blocks of a distributed register. In one aspect, the present invention embraces a computerized system, and an associated method and computer program product for validating one or more blocks of a distributed register.

The system includes a classical computer apparatus and a quantum optimizer in communication with the classical computer apparatus. The classical computer apparatus is configured for receiving an interaction, authenticating the interaction, creating a block representing the interaction to be placed in a distributed register, transmitting the block representing the interaction to the quantum optimizer. The quantum optimizer in response to receiving the block representing the interaction, validates the block and transmits the validated block to the validation application.

In some embodiments, the validation application is configured for updating the distributed register with the validated block.

In some embodiments, the quantum optimizer is a node in a distributed register network associated with the distributed register.

In some embodiments, the classical computer apparatus is a node in a distributed register network associated with the distributed register.

In some embodiments, the block comprises more than one interactions.

In some embodiments, the quantum optimizer validates the block based on generating a hash for the block.

In some embodiments, the hash for the block meets a difficulty level defined in the block.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described some embodiments of the present invention in general terms, reference will now be made to the accompanying drawings, where:

FIG. 1 presents a technical components of a system for generating an enhanced polymorphic quantum enabled firewall, in accordance with an embodiment of the present invention;

FIG. 2 presents a block diagram illustrating the quantum optimizer of FIG. 1, in accordance with embodiments of the present invention;

FIG. 3 presents block diagram illustrating the exposure analysis system of FIG. 1, in accordance with embodiments of the present invention; and

FIG. 4 presents a process flow for validating one or more blocks of a distributed register, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, a quantum computer is any computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2ⁿ states simultaneously. By comparison, a classical computer can only be in one of the 2ⁿ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. Nos. 9,400,499, 9,207,672, each of which is incorporated herein by reference in its entirety.

In accordance with embodiments of the invention, the terms “entity” and “third party system” may include any organization that processes financial transactions including, but not limited to, banks, credit unions, savings and loan associations, investment companies, stock brokerages, resource management firms, insurance companies and the like. In accordance with embodiments of the invention, the terms “third party system” and “other third party systems” may include any organizations including, but not limited to, photo identification issuing agencies, network managing organizations, email managing organizations, and/or the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

“Distributed register,” or “distributed development platform” as used herein may also be referred to as a “distributed ledger,” as used herein may refer to a structured list of data records that is decentralized and distributed amongst a plurality of computing systems and/or devices. In some embodiments, the distributed ledger may use a linked block structure.

“Linked block,” “linked block structure,” “linked structure,” or “blockchain” as used herein may refer to a data structure which may comprise a series of sequentially linked “blocks,” where each block may comprise data and metadata. The “data” within each block may comprise one or more “data record” or “transactions,” while the “metadata” within each block may comprise information about the block, which may include a timestamp, a hash value of data records within the block, a pointer (e.g., a hash value) to the previous block in the linked block structure, and/or any additional data created by the system of the present invention. In this way, beginning from an originating block (e.g., a “genesis block”), each block in the linked block structure is linked to another block via the pointers within the block headers. If the data or metadata within a particular block in the linked block structure becomes corrupted or modified, the hash values found in the header of the affected block and/or the downstream blocks may become mismatched, thus allowing the system to detect that the data has been corrupted or modified. In some embodiments of the present invention, a user may submit data associated with the creation of a new block associated with the linked block structure. For example, a user may initiate a transaction, where the data associated with the transaction is stored in a new block linked with the transaction.

A “linked block ledger” may refer to a distributed ledger which uses linked block data structures. Generally, a linked block ledger is an “append only” ledger in which the data within each block within the linked block ledger may not be modified after the block is added to the linked block ledger; data may only be added in a new block to the end of the linked block ledger. In this way, the linked block ledger may provide a practically immutable ledger of data records over time.

“Permissioned distributed ledger” as used herein may refer to a linked block ledger for which an access control mechanism is implemented such that only known, authorized users may take certain actions with respect to the linked block ledger (e.g., add new data records, participate in the consensus mechanism, or the like). Accordingly, “unpermissioned distributed ledger” as used herein may refer to a linked block ledger without an access control mechanism.

“Private distributed ledger” as used herein may refer to a linked block ledger accessible only to users or devices that meet specific criteria (e.g., authorized users or devices of a certain entity or other organization). Accordingly, a “public distributed ledger” is a linked block ledger accessible by any member or device in the public realm. In some embodiments of the present invention, the distributed ledger being described herein may be a permissioned distributed ledger. In some embodiments of the present invention, the distributed ledger being described herein may be a private distributed ledger.

“Node” as used herein may refer to a computing system on which the distributed ledger is hosted. In some embodiments, each node maintains a full copy of the distributed ledger. In this way, even if one or more nodes become unavailable or offline, a full copy of the distributed ledger may still be accessed via the remaining nodes in the distributed ledger system. That said, in some embodiments, the nodes may host a hybrid distributed ledger such that certain nodes may store certain segments of the linked block ledger but not others.

“Consensus,” “consensus algorithm,” or “consensus mechanism” as used herein may refer to the process or processes by which nodes come to an agreement with respect to the contents of the distributed ledger. Changes to the ledger (e.g., addition of data records) may require consensus to be reached by the nodes in order to become a part of the authentic version of the ledger. In this way, the consensus mechanism may ensure that each node maintains a copy of the distributed ledger that is consistent with the copies of the distributed ledger hosted on the other nodes; if the copy of the distributed ledger hosted on one node becomes corrupted or compromised, the remaining nodes may use the consensus algorithm to determine the “true” version of the distributed ledger. The nodes may use various different mechanisms or algorithms to obtain consensus, such as proof-of-work (“PoW”), proof-of-stake (“PoS”), practical byzantine fault tolerance (“PBFT”), proof-of-authority (“PoA”), or the like.

Typically, validation of one or more blocks in a distributed register is a resource intensive process and needs to be verified by one or more validators of a distributed register network. Classical computing apparatus do not have the necessary computational power to validate the one or more blocks, thereby causing a delay in updating the one or more blocks in the distributed register. As such, there exists a need for a system to improve the efficiency of the updating the one or more blocks in the distributed register. The present invention proposes a new and efficient way to overcome the aforementioned problems as described in detail below.

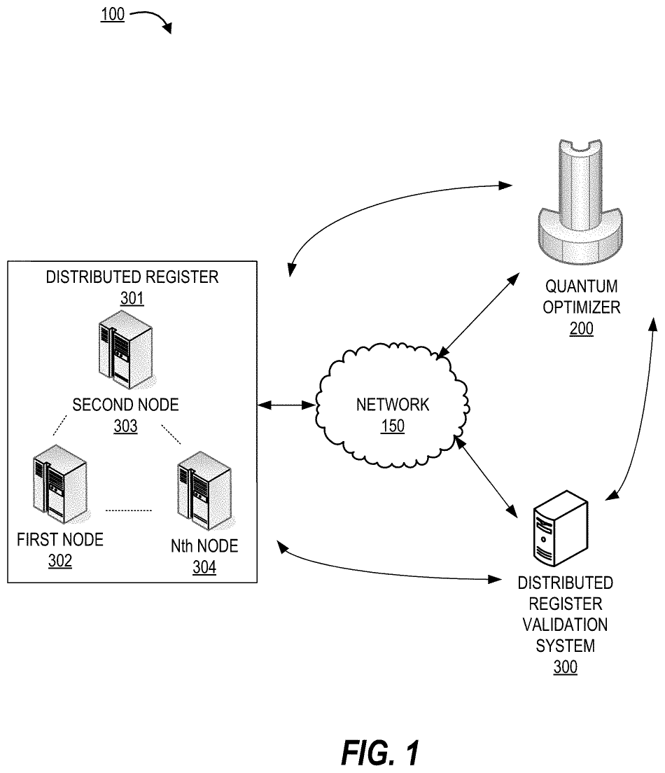

FIG. 1 provides a block diagram illustrating an environment 100 for validating one or more blocks of a distributed register. As depicted in FIG. 1, the operating environment 100 typically includes a distributed register validation system 300 interacting with a quantum optimizer 200, a distributed register 301, using a network 150. In some embodiments, the distributed register validation system 300 may be maintained by an entity. In some embodiments, the entity may be a financial institution. In such embodiments, the distributed register may be used for performing one or more transactions. As further illustrated in FIG. 1, an exemplary quantum optimizer 200 that can be used in parallel with the distributed register validation system 300 to solve optimization problems is presented. In this regard, the distributed register validation system 300 may be used to perform classical digital processing tasks described in the present systems and methods.

In some embodiments, the distributed register 301 comprises one or more nodes (e.g., first node 302, second node 303, through nth node 304). In some embodiments, the distributed register 301 may be a private distributed register associated with the entity. In such embodiments, one or more entity systems associated with the entity may be one or more nodes of the distributed register 301. In some embodiments, the distributed register 301 may be a public distributed register. In some embodiments, the distributed register validation system 300 and/or the quantum optimizer 200 may be one or more nodes of the distributed register 301. In some embodiments, there may be one or more users, where the one or more users may be nodes of the distributed register 301.

The network 150 may be a system specific distributive network receiving and distributing specific network feeds and identifying specific network associated triggers. The network 150 may also be a global area network (GAN), such as Internet 151, a wide area network (WAN), a local area network (LAN), or any other type of network or combination of networks. The network 150 may provide for wireline, wireless, or a combination wireline and wireless communication between devices on the network 150.

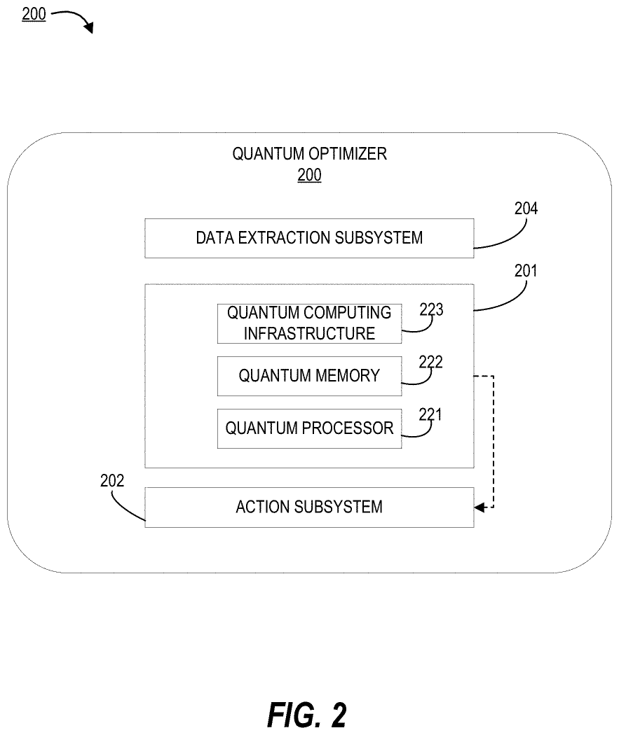

FIG. 2 is a schematic diagram of an exemplary Quantum Optimizer 200 that can be used in parallel with a classical computer to solve optimization problems. The Quantum Optimizer 200 is comprised of a Data Extraction Subsystem 204, a Quantum Computing Subsystem 201, and an Action Subsystem 205. As used herein, the term “subsystem” generally refers to components, modules, hardware, software, communication links, and the like of particular components of the system. Subsystems as contemplated in embodiments of the present invention are configured to perform tasks within the system as a whole.

As depicted in FIG. 2, the Data Extraction Subsystem 204 communicates with the distributed register validation system 300 to extract data for optimization. It will be understood that any method of communication between the Data Extraction Subsystem 204 and the network includes, but is not limited to wired communication, Radiofrequency (RF) communication, Bluetooth WiFi, and the like. The Data Extraction Subsystem 204 then formats the data for optimization in the Quantum Computing Subsystem.

As further depicted in FIG. 2, the Quantum Computing Subsystem 201 comprises a Quantum Computing Infrastructure 223, a Quantum Memory 222, and a Quantum Processor 221. The Quantum Computing Infrastructure 223 comprises physical components for housing the Quantum Processor 221 and the Quantum Memory 222. The Quantum Computer Infrastructure 223 further comprises a cryogenic refrigeration system to keep the Quantum Computing Subsystem 201 at the desired operating conditions. In general, the Quantum Processor 221 is designed to perform adiabatic quantum computation and/or quantum annealing to optimize data received from the Data Extraction Subsystem 204. The Quantum Memory 222 is comprised of a plurality of qubits used for storing data during operation of the Quantum Computing Subsystem 201. In general, qubits are any two-state quantum mechanical system. It will be understood that the Quantum Memory 222 may be comprised of any such two-state quantum mechanical system, such as the polarization of a single photon, the spin of an electron, and the like.

The Action Subsystem 202 communicates the optimized data from the Quantum Computing Subsystem 201 back to the exposure analysis system. It will be understood that any method of communication between the Data Extraction Subsystem 204 and the network includes, but is not limited to wired communication, Radiofrequency (RF) communication, Bluetooth WiFi, and the like.

In accordance with the present systems and methods, an on-board quantum optimizer may be employed to perform real-time optimizations to generate strong cryptographic keys more quickly and more reliably than a digital computing system. Because a quantum computing device inherently performs optimization in its natural evolution, quantum optimizer is particularly well-suited to solve optimization problems.

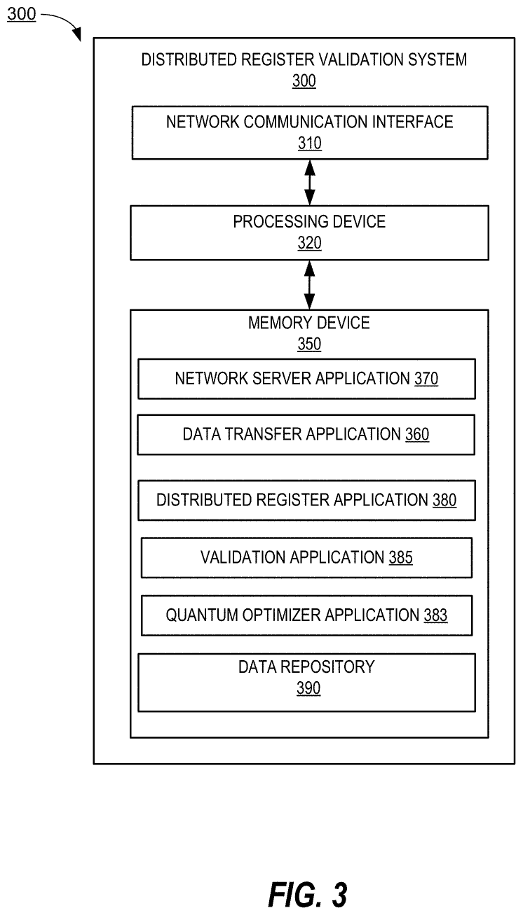

FIG. 3 presents a block diagram illustrating the distributed register validation system 300, in accordance with embodiments of the invention. The distributed register validation system 300 includes one or more processing devices 320 operatively coupled to a network communication interface 310 and a memory device 350. In certain embodiments, the distributed register validation system 300 is operated by an entity, such as a financial institution. The distributed register validation system 300 is configured to perform classical computer operations described in process flows of the present invention.

It should be understood that the memory device 350 may include one or more databases or other data structures/repositories. The memory device 350 also includes computer-executable program code that instructs the processing device 320 to operate the network communication interface 310 to perform certain communication functions of the distributed register validation system 300 described herein. In one embodiment of the distributed register validation system 300, the memory device 350 includes, but is not limited to, a network server application 370, a data transfer application 360, a distributed register application 380, validation application 385, quantum optimizer application 383, and a data repository 390, and other computer-executable instructions or other data. The computer-executable program code of the network server application 370, the data transfer application 360, the distributed register application 380, the validation application 385, and the quantum optimizer application 383 may instruct the processing device 320 to perform certain logic, data-processing, and data-storing functions of the distributed register validation system 300 described herein, as well as communication functions of the distributed register validation system 300.

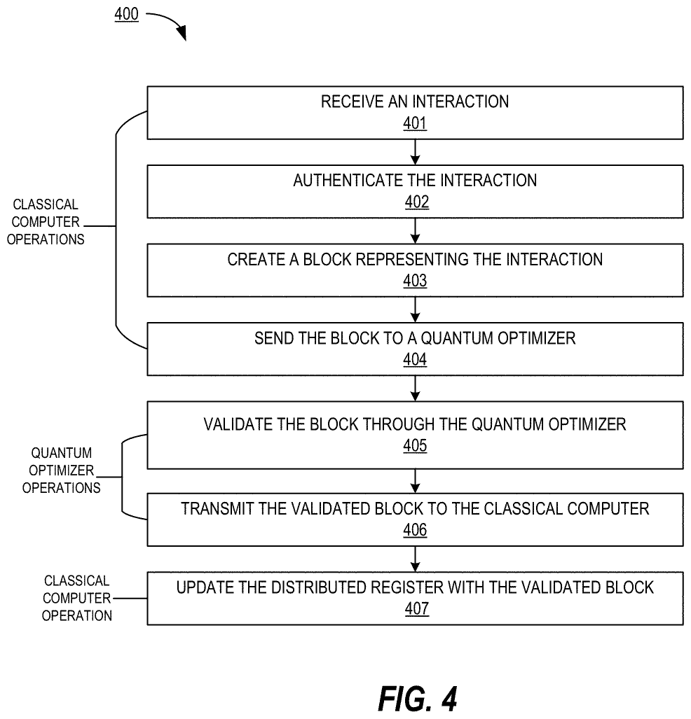

In some embodiments, the quantum optimizer application 383 allows communication with the quantum optimizer 200 using the network communication interface 310. The distributed register application 380 allows for communication with the distributed register 301. The validation application 385 allows for performing one or more steps of the process flow described in FIG. 4. The data transfer application 360 facilitates the transfer of the captured data from the distributed register validation system 300 to other systems on the network 150 and from the other system on the network 150 to the distributed register validation system 300. In some embodiments, the distributed register application 380, the quantum application 383, the data transfer application 360, and the validation application 385 may be a part of a single application.

As used herein, a “communication interface” generally includes a modem, server, transceiver, and/or other device for communicating with other devices on a network. The network communication interface 310 is a communication interface having one or more communication devices configured to communicate with one or more other devices on the network 150, such the quantum optimizer 200 an the distributed register network. The processing device 320 is configured to use the network communication interface 310 to transmit and/or receive data and/or commands to and/or from the other devices connected to the network 150.

FIG. 4 is a high level process flow of an embodiment of the present invention. In some embodiments, the classical computer and/or the quantum optimizer may be nodes of a distributed register network. As depicted in FIG. 4, a classical computer begins the process flow 400 at step 401 by receiving an interaction. In some embodiments, the validation application of the classical computer may determine that an interaction/transaction was received from a user of a distributed register network. In some embodiments, the validation application may determine more than one interactions were received from one or more users of a distributed register network.

At step 402, the classical computer then authenticates the interaction. In some embodiments, the validation application of the classical computer may perform authentication through cryptographic keys or data strings. At step 403, the classical computer creates a block representing the interaction. In some embodiments, the classical computer may verify the interaction before creating the block. For example, the classical computer may verify that digital resources (e.g., digital currency, NFT, or the like) exist in the user's account who initiated the interaction to complete the interaction. In some cases, the classical computer may communicate with one or more other nodes of the distributed register network to verify the interaction, where the one or more other nodes comprise information associated with historical incoming and outgoing interactions. The block created by the classical computer may comprise at least information associated with previous block of the distributed register and information associated with the transaction. In some embodiments, the classical computer may insert more than one transactions into the created block. In such embodiments, the classical computer may verify all the transactions before inserting the transactions into the created block.

At step 404, the classical computer sends the block to the quantum optimizer. At step 405, the quantum optimizer, in response to receiving the block from the classical computer validates the block. Validation of the block may comprise generation of a hash for the block, where the generation of the block may require high computational power to meet the difficulty requirements set by the block. Difficulty requirements set for the block may vary based on the number of nodes in the distributed register, number of blocks, number of users, or the like. For example, if there are large number of users, the difficulty level may be set high. Difficulty level/requirements set for the block define the number of zeroes a hash generated for the block should have for accepting it to be a valid block in the distributed register. Generation of the block may further comprise generation of a nonce value, where the nonce value when combined with the previous hash and then encrypted or twice encrypted results in a hash with ‘X’ number of zeroes as set by the difficulty level. Once the valid hash is generated by the quantum optimizer, the valid hash is included in the validated block and transmitted back to the classical computer as shown in step 406. Once the classical computer receives the validated block from the quantum optimizer, the classical computer updates the distributed register with the validated block. Before updating the distributed register, the classical computer may verify that the generated hash meets the difficulty level of the block.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another. While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A computer system for validating one or more blocks of a distributed register, comprising:
a classical computer apparatus comprising:
a processor;
a memory; and
a validation application that is stored in the memory and executable by the processor;
a quantum optimizer in communication with the classical computer apparatus, the quantum optimizer comprising:
a quantum processor; and
a quantum memory;
wherein the validation application is configured for:
receiving an interaction;
authenticating the interaction;
creating a block representing the interaction to be placed in a distributed register;
transmitting the block representing the interaction to the quantum optimizer;
wherein the quantum optimizer is configured for:
in response to receiving the block representing the interaction, validating the block; and
transmitting the validated block to the validation application.

2. The computer system of claim 1, wherein the validation application is configured for updating the distributed register with the validated block.

3. The computer system of claim 1, wherein the quantum optimizer is a node in a distributed register network associated with the distributed register.

4. The computer system of claim 1, wherein the classical computer apparatus is a node in a distributed register network associated with the distributed register.

5. The computer system of claim 1, wherein the block comprises more than one interactions.

6. The computer system of claim 1, wherein the quantum optimizer validates the block based on generating a hash for the block.

7. The computer system of claim 6, wherein the hash for the block meets a difficulty level defined in the block.

8. A computer program product for validating one or more blocks of a distributed register, comprising a non-transitory computer-readable storage medium having computer-executable instructions for causing a classical computer apparatus comprising to:
receiving an interaction;
authenticating the interaction;
creating a block representing the interaction to be placed in a distributed register;
transmitting the block representing the interaction to a quantum optimizer;
wherein the quantum optimizer is configured for:
in response to receiving the block representing the interaction, validating the block; and
transmitting the validated block to a validation application in the classical computer apparatus.

9. The computer program product of claim 8, wherein the validation application is configured for updating the distributed register with the validated block.

10. The computer program product of claim 8, wherein the quantum optimizer is a node in a distributed register network associated with the distributed register.

11. The computer program product of claim 8, wherein the classical computer apparatus is a node in a distributed register network associated with the distributed register.

12. The computer program product of claim 8, wherein the block comprises more than one interactions.

13. The computer program product of claim 8, wherein the quantum optimizer validates the block based on generating a hash for the block.

14. A method for validating one or more blocks of a distributed register, comprising:
receiving, via a classical computer apparatus, an interaction;
authenticating, via a classical computer apparatus, the interaction;
creating, via a classical computer apparatus, a block representing the interaction to be placed in a distributed register;
transmitting, via a classical computer apparatus, the block representing the interaction to a quantum optimizer;
in response to receiving the block representing the interaction, validating, via the quantum optimizer, the block; and
transmitting, via the quantum optimizer, the validated block to a validation application in the classical computer apparatus.

15. The method of claim 14, wherein the validation application is configured for updating the distributed register with the validated block.

16. The method of claim 14, wherein the quantum optimizer is a node in a distributed register network associated with the distributed register.

17. The method of claim 14, wherein the classical computer apparatus is a node in a distributed register network associated with the distributed register.

18. The method of claim 14, wherein the block comprises more than one interactions.

19. The method of claim 14, wherein the quantum optimizer validates the block based on generating a hash for the block.

20. The method of claim 19, wherein the hash for the block meets a difficulty level defined in the block.
